(19) United States
(12) Patent Application Publication
(10) Pub. No.: US 2014/0255747 A1
(43) Pub. Date: Sep. 11, 2014

(54) HEAT DISSIPATING BATTERY MODULE

(71) Applicant: AMITA TECHNOLOGIES INC LTD., Taoyuan County (TW)

(72) Inventors: Jing-Yih CHERNG, Taoyuan County (TW); Hou-Chi CHEN, Taoyuan County (TW); Kung-Hao CHENG, Taoyuan County (TW)

(73) Assignee: AMITA TECHNOLOGIES INC LTD., Taoyuan County (TW)

(21) Appl. No.: 13/787,128

(22) Filed: Mar. 6, 2013

(51) Int. Cl. H01M 10/50; H01M 2/06; H01M 2/02

(52) U.S. Cl. CPC H01M 10/50; H01M 2/0202; H01M 2/0237; H01M 2/06
USPC 429/120

(57) ABSTRACT

A heat dissipating module with a good heat dissipating effect is disclosed. The structure includes a metal shell, at least one battery cell, and an elastic body. The metal shell has an accommodating space, and one side of the accommodating is an opening. A top cover is disposed on the opening, and the top cover has a plural of grooves. The battery cell is disposed in the accommodating space, and has an anode tab and a cathode tab on a top of the battery cell. The anode tab and cathode tab are exposed out of the grooves. The elastic body is disposed at a lateral side of the battery cell. The elastic body pushes the battery cell for the battery cell leaning against the metal shell with most surface area thereof.

### BACKGROUND OF THE INVENTION

1. Field of the Invention

The present invention generally relates to a battery module and, in particular to a heat dissipating battery module applied in an electronic device.

2. Description of Related Art

Electronic products bring a lot of convenience in life for people, especially portable electronic products or electrical vehicles and related products. The presence of the battery is very important to electrical products for operating normally. As the operating time of electronic products is extended, the usage time of batteries is increased correspondingly. In response to such a demand, a high efficiency charging battery with environment friendly characteristic will be able to meet the demand.

The battery materials of a high efficiency charging battery performing ion-exchange will inevitably produce a large amount of heat during charging or discharging. The working temperature inside will cause thermal resistance effect and lower down the charging or discharging efficiency. Therefore, how to dissipate heat of batteries is important for battery efficiency in order to stabilize the working temperature.

However, battery cells are disposed inside the main body of a battery nowadays. The heat produced by the battery cells are conducted to the main body directly, and then the main body exchanges the heat with external air for heat dissipating. Though the battery cells and the main body are loosely fitted, the air flow contacts the surface of the main body for heat exchanging when in use. Because the battery cells and the main body have limited contacting area with a lower efficiency of heat exchanging, heat will be produced and accumulated inside the main body. The working temperature and the heat resistance inside are rising continuously, and that will affect charging and discharging efficiency a lot.

In view of the above drawbacks, the Inventor proposes the present invention based on his expert knowledge and elaborate researches in order to solve the problems of related art.

### SUMMARY OF THE INVENTION

Accordingly, an object of the present invention is to provide a heat dissipating module with a good heat dissipating effect.

In order to achieve the object mentioned above, the present invention includes a metal shell, at least one battery cell, and an elastic body. The metal shell has an accommodating space, and one side of the accommodating is an opening. A top cover is disposed on the opening, and the top cover has a plural of grooves. The battery cell is disposed in the accommodating space, and has an anode tab and a cathode tab on a top of the battery cell. The anode tab and cathode tab are exposed out of the grooves. The elastic body is disposed at a lateral side of the battery cell. The elastic body pushes the battery cell for the battery cell leaning against the metal shell with most surface area thereof.

Another object of the present invention is to provide a heat dissipating module that the quan

Comparing to the related art, the present invention has the following effects.

1. The metal shell is provided for accommodating battery cells with good heat conductivity, and that is used for improving heat conductivity of plastic shell.

2. An elastic body is disposed for the metal shell contacting battery cells area with most surface area thereof, thus the heat produced from the battery cells can be conducted to the metal shell more quickly by the large contacting area.

3. The elastic body provides resisting force for the battery cells contacting with the metal shell by large contacting area. Meanwhile, the elastic body can also contain heat conducting media that will be helpful for conducting heat produced by the battery cells.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective exploded view according to the present invention;

FIG. 2 is a perspective view of the present invention;

FIG. 3 is a longitudinal cross sectional schematic view of the present invention;

FIG. 4 is a transverse cross-sectional schematic view of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

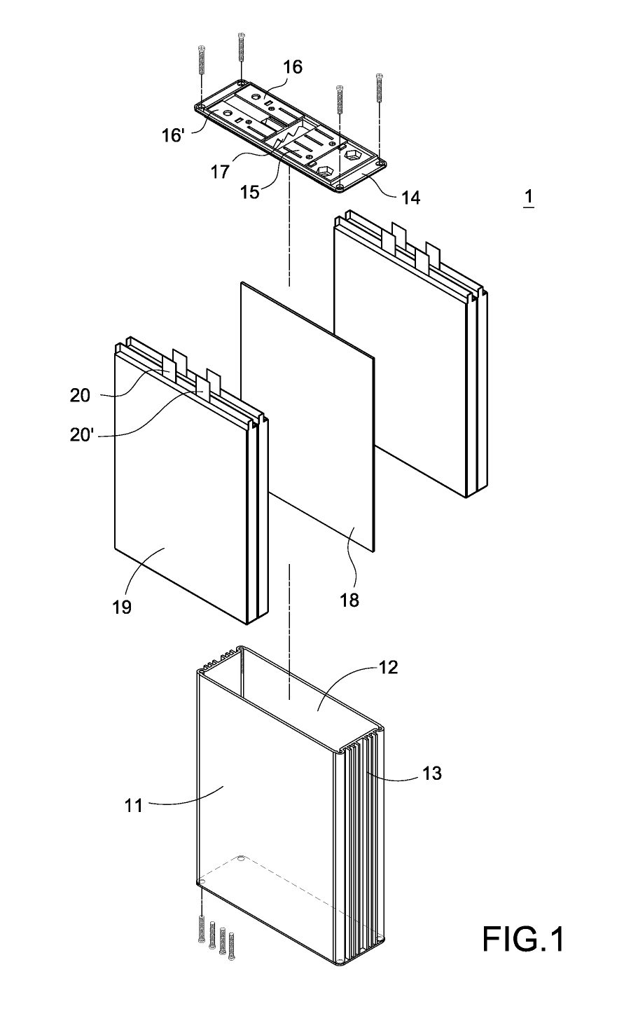

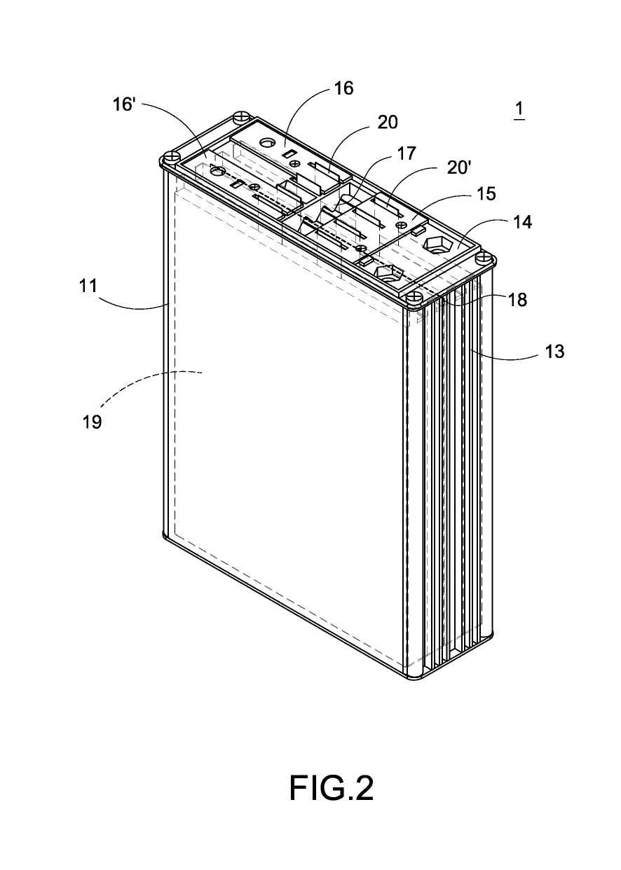

Please refer to FIG. 1 and FIG. 2, they depict a perspective exploded view and a perspective view of the present invention. A heat dissipating battery module 1 of the present invention includes a metal shell 11, at least one battery cell 19 and an elastic body 18.

The metal shell 11 having an accommodating space is made of aluminum or aluminum alloy material. One side of the accommodating is an opening 12, and a top cover 14 having a plural of grooves is disposed on the opening 12. Moreover, a plural of connecting holes are provided in a peripheral of the metal shell 11, and two opposite sides of the metal shell 11 are provided with a plural of heat dissipating fins 13. There are three electrodes 15, 16, 16′ disposed on the top cover 14, and a plural of grooves are provided on the electrodes 15, 16, 16′.

The battery cell 19 has an anode tab 20 and a cathode tab 20′ on a top of The battery cell 19 is disposed in the accommodating space, and the anode tab 20 and the cathode tab 20′ are exposed out of the grooves. There are four battery cells 19 in the present embodiment. The position and the quantity of the grooves on the top cover 14 are disposed with respect to the position and the quantity of the anode tab 20 and the cathode tab 20′ of the battery cell 19.

The elastic body 18 is disposed at a lateral side of the battery cell 19, and the elastic body 18 pushes the battery cell 19 for leaning against the metal shell 11 with most surface area of the side leaning against the metal shell 11. The elastic body 18 is disposed between two adjacent battery cells 19, and the elastic body 18 is made of silicon or rubber material.

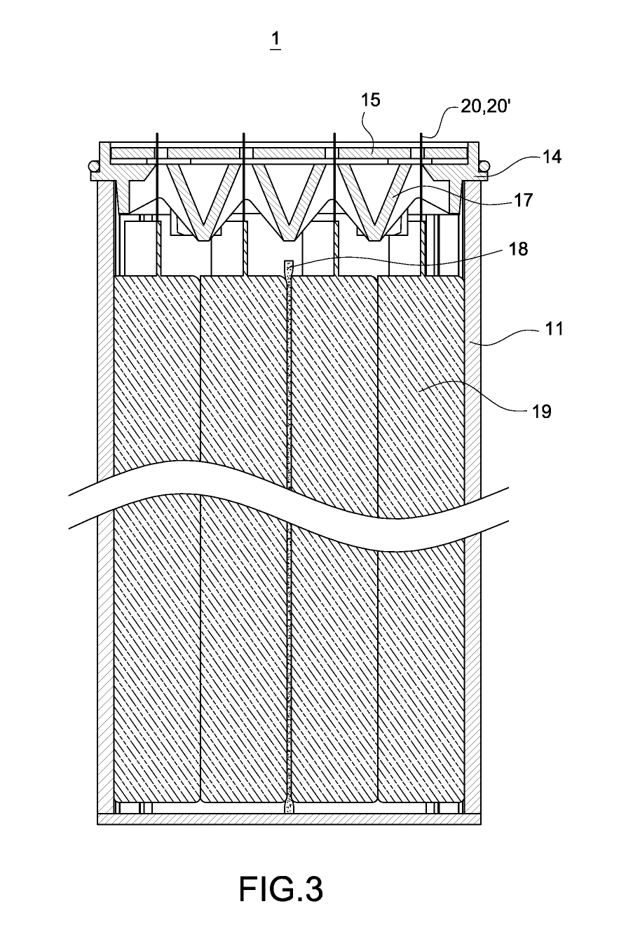

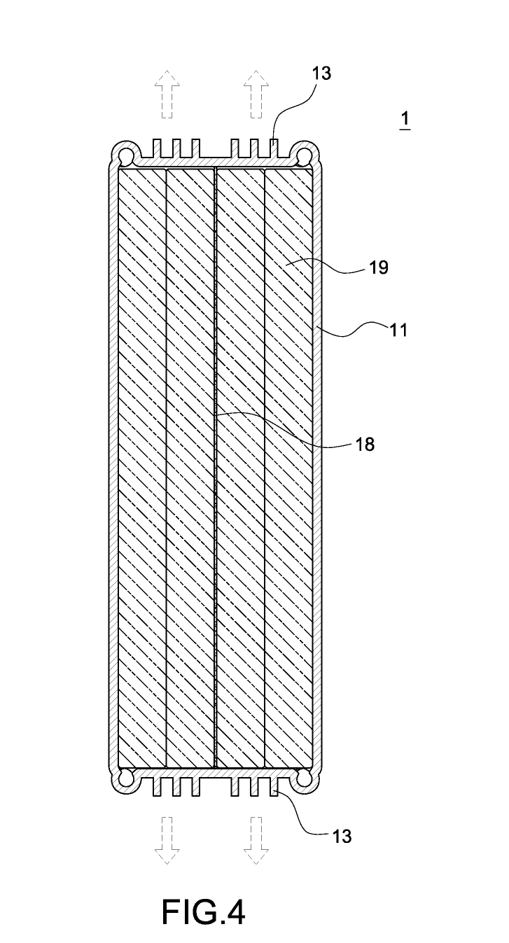

Please refer to FIG. 3 and FIG. 4, they depict a longitudinal cross sectional schematic view and a transverse cross-sectional schematic view of the present invention. The elastic body 18 is disposed between two adjacent battery cells 19, and then the elastic body 18 is placed together with the battery cells 19 in the accommodating space of the metal shell 11. The top cover 14 covers the opening 12 of the metal shell 11. The anode tab 20 and the cathode tab 20′ on tops of the four battery cells 10 pass through the grooves of three electrodes 15, 16, 16′ respectively. The anode tab 20 and the cathode tab 20′ of four battery cells 19 are connected with the three electrodes 15, 16, 16′ and exposed out. A bottom edge of the top cover 14 is provided with a plural of jagged protrusions 17 for resisting against the battery cells 19.

Furthermore, battery cells 19 on two sides of the elastic body 18 are pushed outwardly by the elastic body 18, and the battery cells 19 on two sides of the elastic body 18 will lean against the metal shell 11 with most surface area thereof. Heat produced from the battery cells 19 on two outer sides of the elastic body 18 will be conducted to the metal shell 12 quickly. Besides, the elastic body 18 can also contain heat conducting media. Thus heat produced by the battery cells 19 conducts to the metal shell 12 for dissipating quickly through the heat dissipating fans 13.

Although the present invention has been described with reference to the preferred embodiment thereof, it will be understood that the invention is not limited to the details thereof Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A heat dissipating battery module, comprising:
a metal shell having an accommodating space, one side of the accommodating being an opening, a top cover disposed on the opening and having a plural of grooves;
at least one battery cell disposed in the accommodating space and having an anode tab and a cathode tab on a top of the battery cell, the anode tab and cathode tab exposed out of the grooves; and
an elastic body disposed at a lateral side of the battery cell, the elastic body pushing the battery cell for the battery cell leaning against the metal shell with most surface area thereof.

2. The battery module according to claim 1, wherein the metal shell is made of aluminum or aluminum alloy material.

3. The battery module according to claim 1, wherein two opposite sides of the metal shell are provided with a plural of heat dissipating fins.

4. The battery module according to claim 1, wherein a bottom edge of the top cover is provided with a plural of jagged protrusions resisting against the battery cell.

5. The battery module according to claim 1, wherein the position and the quantity of the grooves are disposed with respect to the position and the quantity of the anode tab and the cathode tab of the battery cell.

6. The battery module according to claim 1, wherein the elastic body contains heat conducting media.

7. The battery module according to claim 1, wherein the elastic body is made of silicon or rubber material.
